(19) United States
(12) Patent Application Publication
(10) Pub. No.: US 2015/0296027 A1
(43) Pub. Date: Oct. 15, 2015

(54) Continuous Browsing Across Devices

(71) Applicant: Nokia Corporation, Espoo (FI)

(72) Inventors: Pawel M. Bak, Chicago, IL (US); Gregory J. Athas, Lisle, IL (US)

(73) Assignee: Nokia Corporation, Espoo (FI)

(21) Appl. No.: 14/248,848

(22) Filed: Apr. 9, 2014

(51) Int. Cl. H04L 29/08

(52) U.S. Cl. CPC H04L 67/148; H04L 67/02; H04L 67/2804

(57) ABSTRACT

A method includes determining at a proxy server that web session(s) corresponding to a first client device are available for downloading by a second client device. The web session(s) originally originated by a particular user using the first client device and comprise browser information, and the first and second client devices are different physical devices. A message is sent from the proxy server to the second client device indicating the proxy server has available the web session(s). Information is downloaded from the proxy server to the second client device for the web session(s). The downloaded information allows the second client device to render corresponding views of the web session(s) at a point where the first client device left off in the web session(s). Apparatus and computer program products are also disclosed. Methods, apparatus, and program products are disclosed for the client device.

### TECHNICAL FIELD

This invention relates generally to devices that perform web browsing and, more specifically, to continuous browsing across such devices.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

It is not uncommon for a web user to own and utilize multiple devices for browsing the internet. For instance, a web user may use a personal computer (PC), tablet, mobile phone, and car interface within a single day. Users will often be in situations where they are switching from one device to another as their day progress (e.g., moving from PC to mobile as they leave for their daily commute). If a user is in the middle of a series of web transactions (typically referred to as a session) with a web content server on one device, he or she has no way to continue this session on another device. For example, a user may, on his or her PC, be reading an article and need to leave before finishing the article. In order to read the same article on their mobile device, he or she will need to manually reproduce all the steps previously performed in order to be able to read said article from the same spot (e.g., locate the web site, enter credentials, find the specific article, and scroll to last position read).

It would be beneficial if the user would be able to start reading the same article when transferring between devices such that browsing can be continuous across the devices.

### SUMMARY

This section contains examples of possible implementations and is not meant to be limiting.

An exemplary method includes determining at a proxy server that one or more web sessions corresponding to a first client device are available for downloading by a second client device, wherein the one or more web sessions originally originated by a particular user using the first client device and comprise browser information, and wherein the first and second client devices are different physical devices. The method includes sending a message from the proxy server to the second client device indicating the proxy server has available the one or more web sessions. The method further includes downloading information from the proxy server to the second client device for the one or more web sessions, wherein the downloaded information allows the second client device to render corresponding views of the one or more web sessions at a point where the first client device left off in the one or more web sessions.

An exemplary apparatus includes one or more processors and one or more memories including computer program code. The one or more memories and the computer program code are configured to, with the one or more processors, cause the apparatus to perform at least the following: determining at a proxy server that one or more web sessions corresponding to a first client device are available for downloading by a second client device, wherein the one or more web sessions originally originated by a particular user using the first client device and comprise browser information, and wherein the first and second client devices are different physical devices; sending a message from the proxy server to the second client device indicating the proxy server has available the one or more web sessions; and downloading information from the proxy server to the second client device for the one or more web sessions, wherein the downloaded information allows the second client device to render corresponding views of the one or more web sessions at a point where the first client device left off in the one or more web sessions.

An exemplary computer program product includes a computer-readable storage medium bearing computer program code embodied therein for use with a computer. The computer program code includes: code for determining at a proxy server that one or more web sessions corresponding to a first client device are available for downloading by a second client device, wherein the one or more web sessions originally originated by a particular user using the first client device and comprise browser information, and wherein the first and second client devices are different physical devices; code for sending a message from the proxy server to the second client device indicating the proxy server has available the one or more web sessions; and code for downloading information from the proxy server to the second client device for the one or more web sessions, wherein the downloaded information allows the second client device to render corresponding views of the one or more web sessions at a point where the first client device left off in the one or more web sessions.

In another exemplary embodiment, an apparatus comprises: means for determining at a proxy server that one or more web sessions corresponding to a first client device are available for downloading by a second client device, wherein the one or more web sessions originally originated by a particular user using the first client device and comprise browser information, and wherein the first and second client devices are different physical devices; means for sending a message from the proxy server to the second client device indicating the proxy server has available the one or more web sessions; and means for downloading information from the proxy server to the second client device for the one or more web sessions, wherein the downloaded information allows the second client device to render corresponding views of the one or more web sessions at a point where the first client device left off in the one or more web sessions.

An additional exemplary embodiment is a method including determining from a proxy server that one or more web sessions corresponding to a first client device are available for downloading by a second client device, wherein the one or more web sessions originally originated by a particular user using the first client device and comprise browser information, and wherein the first and second client devices are different physical devices. The method further includes downloading information, by the second client device and from the proxy server, responsive to the determining for the one or more web sessions, wherein the downloaded information allows the second client device to render corresponding views of the one or more web sessions at a point where the first client device left off in the one or more web sessions.

An exemplary apparatus includes one or more processors and one or more memories including computer program code. The one or more memories and the computer program code are configured to, with the one or more processors, cause the apparatus to perform at least the following: determining from a proxy server that one or more web sessions corresponding to a first client device are available for downloading by a second client device, wherein the one or more web sessions originally originated by a particular user using the first client device and comprise browser information, and wherein the first and second client devices are different physical devices; and downloading information, by the second client device and from the proxy server, responsive to the determining for the one or more web sessions, wherein the downloaded information allows the second client device to render corresponding views of the one or more web sessions at a point where the first client device left off in the one or more web sessions.

An exemplary computer program product includes a computer-readable storage medium bearing computer program code embodied therein for use with a computer. The computer program code includes: code for determining from a proxy server that one or more web sessions corresponding to a first client device are available for downloading by a second client device, wherein the one or more web sessions originally originated by a particular user using the first client device and comprise browser information, and wherein the first and second client devices are different physical devices; and code for downloading information, by the second client device and from the proxy server, responsive to the determining for the one or more web sessions, wherein the downloaded information allows the second client device to render corresponding views of the one or more web sessions at a point where the first client device left off in the one or more web sessions.

A further exemplary embodiment is an apparatus comprising: means for determining from a proxy server that one or more web sessions corresponding to a first client device are available for downloading by a second client device, wherein the one or more web sessions originally originated by a particular user using the first client device and comprise browser information, and wherein the first and second client devices are different physical devices; and means for downloading information, by the second client device and from the proxy server, responsive to the determining for the one or more web sessions, wherein the downloaded information allows the second client device to render corresponding views of the one or more web sessions at a point where the first client device left off in the one or more web sessions.

### BRIEF DESCRIPTION OF THE DRAWINGS

In the attached Drawing Figures:

FIG. 1 is a simplified block diagram of a system used to illustrate an exemplary embodiment;

FIG. 2 is another simplified block diagram of an exemplary architecture used to illustrate an exemplary embodiment;

FIGS. 3A, 3B, and 3C, collectively referred to as FIG. 3, where FIGS. 3A and 3C illustrate different possible examples, is a block diagram of an exemplary logic flow diagram performed by a client device for continuous browsing across devices that illustrates the operation of an exemplary method, a result of execution of computer program instructions embodied on a computer readable memory, and/or functions performed by logic implemented in hardware, in accordance with exemplary embodiments herein; and

FIGS. 4A, 4B, 4C, and 4D, collectively referred to as FIG. 4, where FIGS. 4A and 4D illustrate different possible examples, is a block diagram of an exemplary logic flow diagram performed by a proxy server for continuous browsing across devices that illustrates the operation of an exemplary method, a result of execution of computer program instructions embodied on a computer readable memory, and/or functions performed by logic implemented in hardware, in accordance with exemplary embodiments herein.

### DETAILED DESCRIPTION OF THE DRAWINGS

Before proceeding with description of the exemplary embodiments, additional description of problems with conventional systems are now provided. Exemplary major issues with previous attempts to provide continuous browsing across devices include the following:

1. The systems require the synchronization of state variables and transmission of these variables between devices. These state variables are generally not a complete representation of the state of the user's browsing session. For instance, typically some state is also kept in the JavaScript application context associated with a page.

2. The systems require re-establishment of connection to a web server. While HTTP (hypertext transfer protocol) communication is generally stateless, it may not be possible to have a new client connect to an existing browsing session without going back through authentication.

3. Devices are typically heterogeneous in their capabilities (e.g., screen size, input method) as well as on the client browser being used (Internet Explorer, WebKit variations, FireFox, each of which is a version of a web browser). Content servers typically will present different content to different devices. For instance, different content may be presented to a user using a Windows operating system on a PC and one using a browser on an iPhone. If state variables are being shared between devices, some state variables may not correctly correlate with the capabilities of the new device.

This invention solves these problems and improves upon the user experience by introducing a proxy web browser that interacts directly with a web content server on behalf of all the user's client devices. A proxy web browser is a server that acts as an agent for various client devices and that interacts with web content servers on behalf of the client devices. This means that from the perspective of the web content servers, the proxy browser is the client with which the web content servers are interacting and all state information is delivered and stored in the proxy browser. The proxy browser can then interact with and deliver an optimized view of the web content to its associated client device. This view is typically reduced in size and complexity, enabling the client to use fewer resources (e.g., central processing unit, memory, network bandwidth). Furthermore, the proxy browser can optimize the physical display of the web content for the target screen and input methods (such as pointer, touch, voice, and the like) that the client device is capable of supporting.

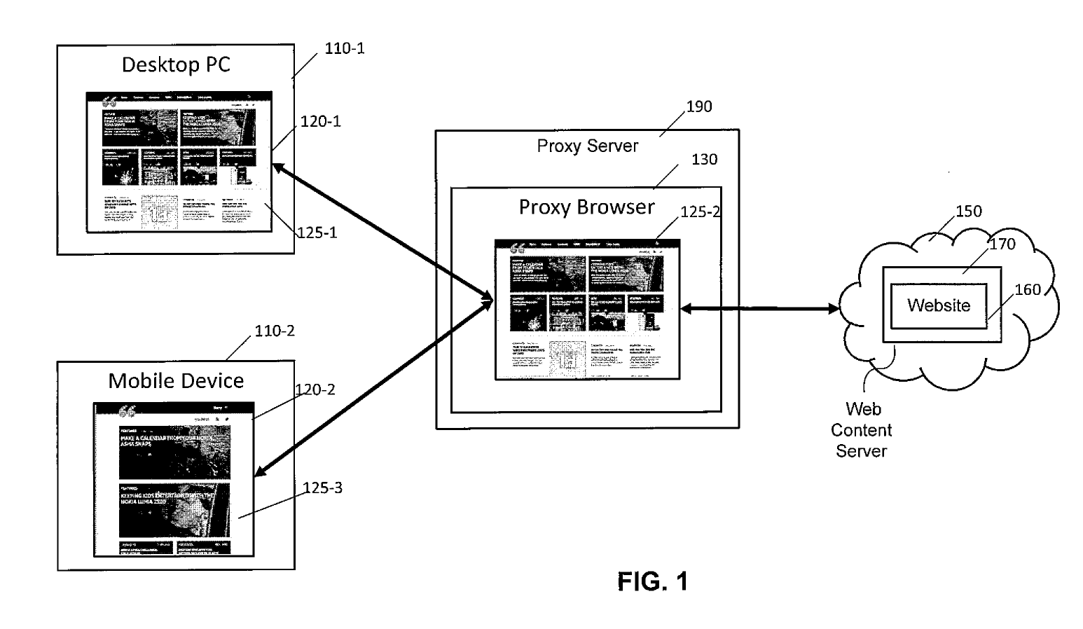

Referring to FIG. 1, a simplified block diagram is shown of a system used to illustrate an exemplary embodiment. In this example, a user starts by using a client device 110 that is a desktop personal computer (PC) 110-1 and viewing a web page 125-1 from the web content server 170 using the web browser 120-1. The web page 125-1 is served by the website 160 in the Internet 150 (or other suitable network). The proxy server 190 has a version of the web page 125-1 shown as web page 125-2 in a proxy browser 130. The user then stops browsing on the desktop PC 110-1 and transitions to using another client device 110 that is a mobile device 110-2, such as a smartphone. The user would like to continue to browse a version of the web page 125-2 using the browser 120-2. The version of the website is shown as 125-3, and is shown in a modified format formatted to fit the web browser 120-2 and the configuration (e.g., screen size and format) for mobile device 110-2.

As stated above, the exemplary embodiments herein improve upon the user experience by, e.g., introducing a proxy browser 130 that interacts directly with the web content server on behalf of the all the user's client devices 110. There is no synchronization of state variables required. The session between the proxy server 190 and the web content server 170 is maintained independently of which client is viewing the content. All state information may be maintained in a single web browser instance (the proxy browser 130) running on the proxy server 190. Different clients 110 merely identify themselves, in an exemplary embodiment, as belonging to the user and then are connected to the running proxy browser 130. Additionally the proxy browser 130 is able to optimize and adapt the resulting content views to work best with each user device (e.g., change display size, scale down images, audio transcription, and the like) using techniques already present in the proxy web service.

Handoff and contention between client devices 110 is achieved by identifying which client device(s) 110 are active at a given time. If a user is using one client device, the client device 110 can tell the proxy server 190 that the client device 110 will disconnect from (e.g., or has been disconnected from) the proxy browser 130 and allow another client device 110 to attach by the following examples: in response to the user exiting the web browser 120-1 on the desktop PC 110-1; or in response to the device being locked (e.g., or going to a low power mode) either manually or after a timeout. When a new client device 110 is started, the client device 110 can check with the proxy server 190 to see if there are any active sessions that it should display. Additionally, device proximity or loss thereof can trigger a session handoff between client devices (e.g., a user grabs their phone and walks away from their PC, severing a Bluetooth connection and indicating that the phone is now the active client device 110). Bluetooth is a wireless technology standard for exchanging data over short distances.

Because the proxy server 190 is executing as an independent agent from the client device 110, it is also possible that the proxy server 190 can execute long running processes (e.g., processes that make take many minutes, or hours, or even days) initiated from one client device 110 and then allow a second client device 110 to view the results when finished. It is generally assumed this feature runs on the proxy web browser 130, but does not need to be limited to this approach. Furthermore, the proxy web browser 130 could be waiting on some other longer running process on another system and then report the results to the different active clients (e.g., once the other system reports the results to the proxy web browser 130). When the user switches client devices 110, the user can see that this process is finished when bringing up the web browser (e.g., 120-1 on mobile device 110-1) or the proxy server 190 can send a push notification to the client device 110 to let the client device 110 know that the results are ready.

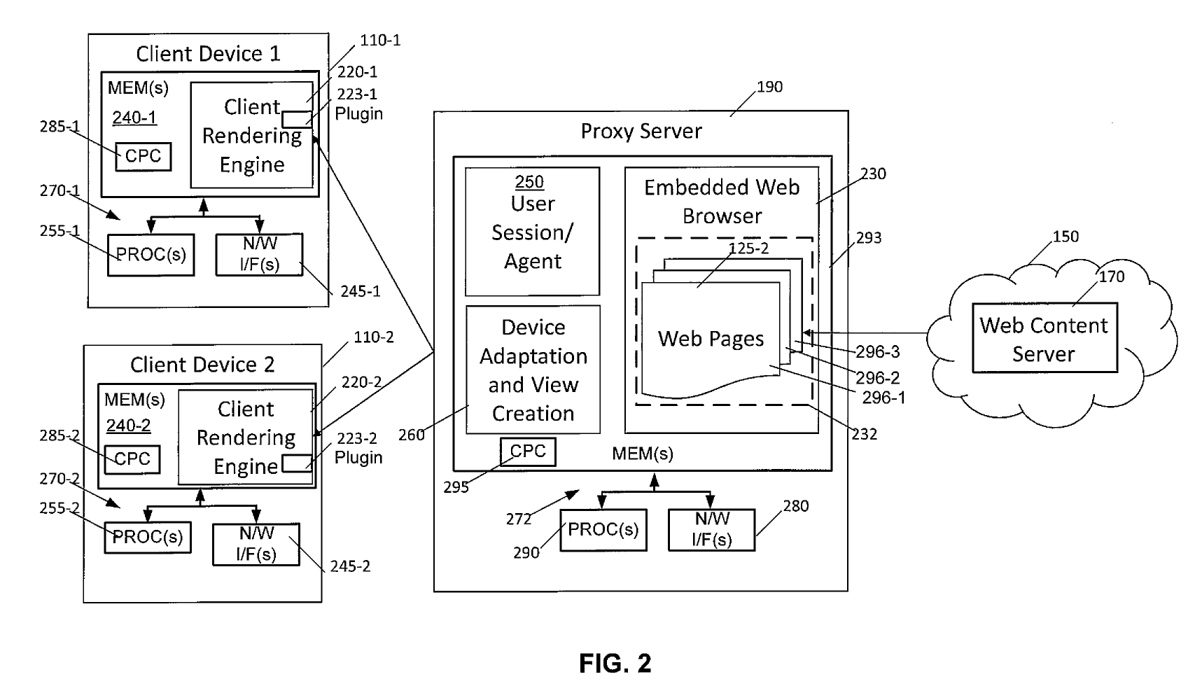

FIG. 2 illustrates an exemplary architecture for exemplary embodiments. Two client devices 110-1 and 110-2 are shown. Client device 1 110-1 includes one or more processors (PROC(s)) 255-1, one or more network interfaces (N/W I/Fs) 245-1, and one or more memories (MEMs) 240-1, interconnected through one or more buses 270-1. The one or more processors 255 may be or include any type of processor suitable for the particular device, such as single or multiple core processors, processors with or without video engines, integrated circuits made specifically for the device 110, logic elements, and the like. The one or more memories 240 may also be or include any type of memory for the particular device, such as removable memory, static random access memory, dynamic random access memory, cache memory, volatile or non-volatile memory, and large storage memories such as hard drives, solid state devices, and the like. The buses 270 may include address, data, and/or control buses and may include any hardware for connecting elements in a client device 110, such as traces on a board, traces in a semiconductor, optical elements, and the like.

The memory 240-1 includes computer program code (CPC) 285-1 and a client rendering engine 220-1. Similarly, the memory 240-2 includes computer program code (CPC) 285-2 and a client rendering engine 220-2.

The client rendering engines 220 may be implemented (in part or completely) as computer program code 285, such that the one or more memories 240 and the computer program code 285 are configured, with the one or more processors 255, to cause the client device 110 to perform operations described herein. In another exemplary embodiment, the client rendering engines 220 may be implemented (in part or completely) as hardware logic that may form part of the processor(s) 255 or may be an adjunct to the processor(s) 255.

The proxy server 190 comprises one or more memories 293 that comprise a user session/agent component 250, an embedded web browser 230, a device adaptation and view creation component 260, and computer program code 295. The proxy server 190 further comprises one or more processors 290 and one or more network interfaces 280, interconnected with the one or more memories 293 by one or more buses 272. The one or more buses 272 may include address, data, and/or control buses and may include any hardware for connecting elements in a server, such as traces on a board, traces in a semiconductor, optical elements, and the like. The one or more processors 290 may be or include any type of processor suitable for the particular device, such as single or multiple core processors, processors with or without video engines, integrated circuits made specifically for the device 110, logic elements, and the like. The one or more memories 293 may also be or include any type of memory for the particular device, such as removable memory, static random access memory, dynamic random access memory, cache memory, volatile or non-volatile memory, and large storage memories such as hard drives, solid state devices, and the like.

The network interfaces 245 and 280 may be wired or wireless network interfaces. The interfaces may use Wi-Fi (a technology that allows an electronic device to exchange data or connect to the internet wirelessly using radio waves), Ethernet, technology for 3G or 4G systems, and the like. The components 230, 250, and 260 may be implemented in the computer program code 295, such that the one or more memories 293 and the computer program code 295 are configured, with the one or more processors 290, to cause the proxy server 190 to perform operations described herein. In another exemplary embodiment, the components 230, 250, and 260 may be implemented (in part or completely) as hardware logic that may form part of the processor(s) 290 or may be an adjunct to the processor(s) 290.

The proxy server 190 contains the following exemplary components:
Embedded Web Browser 230—In this example, a commercial or custom web rendering engine that can load web pages and render them, e.g., into a display buffer (display buffer 232 in this example) as windows 296 (of which 296-1, 296-2 and 296-3 are shown in this example). When a web page 125-2 is rendered, its active state is kept in the web browser 230. This includes, for instance, the JavaScript (a computer programming language) context of a page. The viewport of the Web Browser may be associated with the attached client devices and render the page to this viewport. In web browsers, the viewport is a visible portion of an entire document. If the document is larger than the viewport, the user can shift the viewport around by scrolling. The proxy browser mirrors the viewport required by the active client. This can change as clients register.
User Session/Agent component 250—This component acts on behalf of the client applications to interact with the web browser 230 as well as store any persistent data associated with the user's interaction with a web page 125-2. For example, cookies are persistent data that may stored on the server on behalf of all clients. In an exemplary embodiment, a user and device combination is identified to the proxy server 190 by a single unique identifier token. In an example herein, a user is identified by this token independent of client device 110. This token may be explicit (e.g., a username) or implicit (e.g., a generated number). When the user initiates a page load or event from a client device 110, the user session/agent component 250 connects to a “window” in the web browser 230 to request the page or invoke the event on the existing page session. The user session/agent component 250 stores persistent state data on behalf of the web browser 230 for web content information like cookies, HTML5 (hypertext markup language 5) persistent storage, and IndexDB (IndexDB is an application programming interface for client-side storage of significant amounts of structured data and for high performance searches on this data using indexes), as non-limiting examples. For certain exemplary embodiments, this state information could be enhanced with data such as scroll position and page zoom.
Device Adaptation and View Creation component 260—The content presented on the client devices 110 may or may not be HTML. Depending on the client device 110, the proxy server 190, via the device adaptation and view creation component 260, can convert the content into a more compact representation such as a series of drawing commands, a bitmap, or a simplified version of HTML. Additionally, this component 260 can perform transformations of a view to ensure that the resulting content fits appropriately on the screen of the client device 110 and uses data formats that the client device 110 can support or run (e.g., optimally).

On each client device 110, there is a Client Rendering Engine (CRE) 220. The CRE 220 may be a commercial web browser, a commercial web browser aided by a plug-in 223 (a plug-in is a software component that adds one or more specific features to an existing software application), a commercial rendering engine embedded in a custom application, or a custom application altogether. In any case the CRE 220 is responsible (in this example) for identifying the user to the proxy server 190, rendering the content provided by the proxy server 190 and generating events to be sent to the proxy server 190. The client rendering engine 220 will also have components to identify when a specific device is no longer actively using the proxy server session. In response to the device being locked, the browser application being exited, or some other event, the CRE 220 will be notified that the current device is not using the session.

When a user starts up another client device 110, the CRE 220 on that device 110 will connect to the proxy server 190 and report the user's ID (identification). If there is an existing session running, the client device 110 will be notified. The client device 110 may then load the active session page view into a tab, create a thumbnail of the active page, or provide some other notification that there is an active session running. In general only a single CRE 220 can be connected to a proxy server session and to avoid contention.

As the browser system (client and server) can support multiple simultaneous browsing sessions (e.g., tabs) this means that all of a user's active web engagements can be viewed and managed across devices. It is noted that the client devices 110 may be any type of computing device, such as wearable devices, televisions, personal computers, tablets, smart phones, and the like.

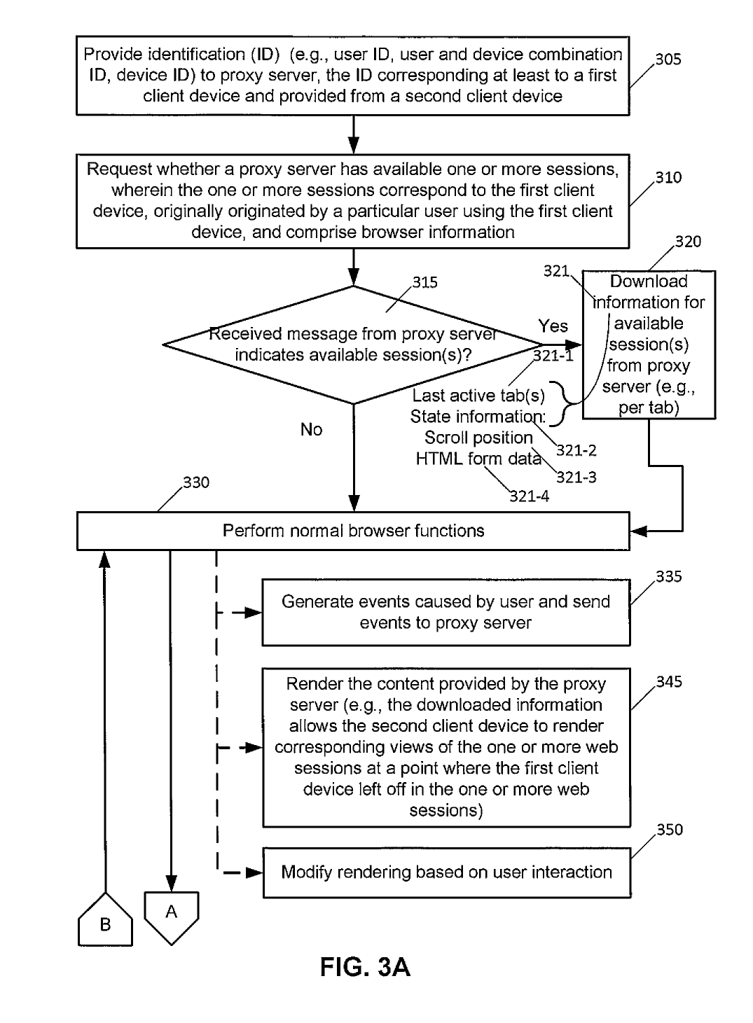

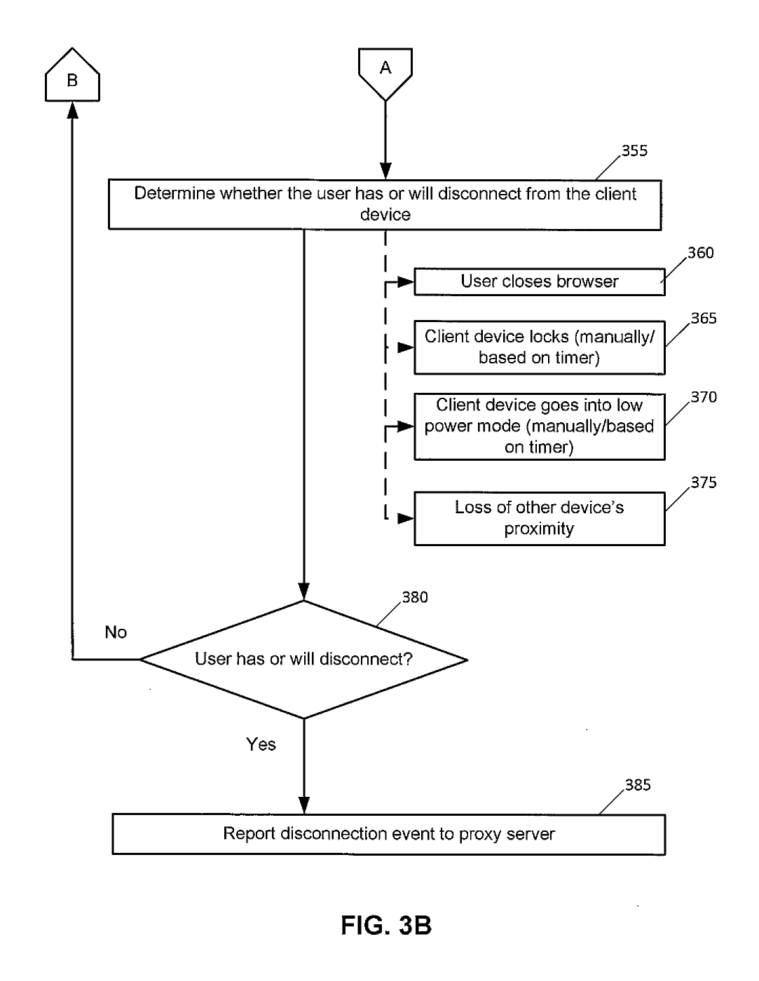

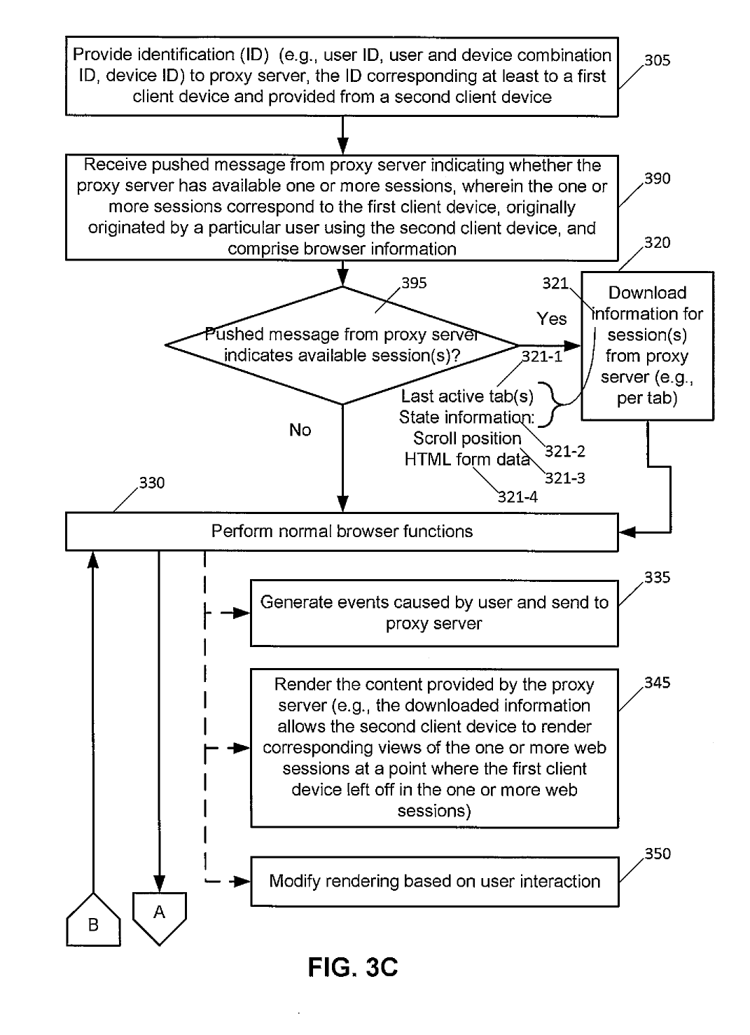

Referring to FIG. 3, which includes both FIGS. 3A, 3B, and 3C, where FIGS. 3A and 3C illustrate different possible examples, a block diagram is shown of an exemplary logic flow diagram performed by a portable device for accessory identification and configuration. FIG. 3 illustrates the operation of an exemplary method, a result of execution of computer program instructions embodied on a computer readable memory, and/or functions performed by logic implemented in hardware, in accordance with exemplary embodiments herein. The blocks in FIG. 3 may be considered to be interconnected means for performing the functions in the blocks. FIGS. 3A and 3B may be considered to be one flow, and FIGS. 3C and 3B may be considered to be another exemplary flow.

In the example of FIGS. 2, 3 and 4, the user is assumed to originally use the client device 110-1 (the “first” client device, such as a PC) and browse the web using the client rendering engine 220-1. The user then causes a disconnection event (e.g., indicates a user has ceased interacting with one or more web sessions, e.g., by closing the client rendering engine 220-1) and proceeds subsequently to use client device 110-2 (the “second” client device, such as a smartphone). The user would like to continue on the client device 110-2 the sessions originally formed using the client device 110-1.

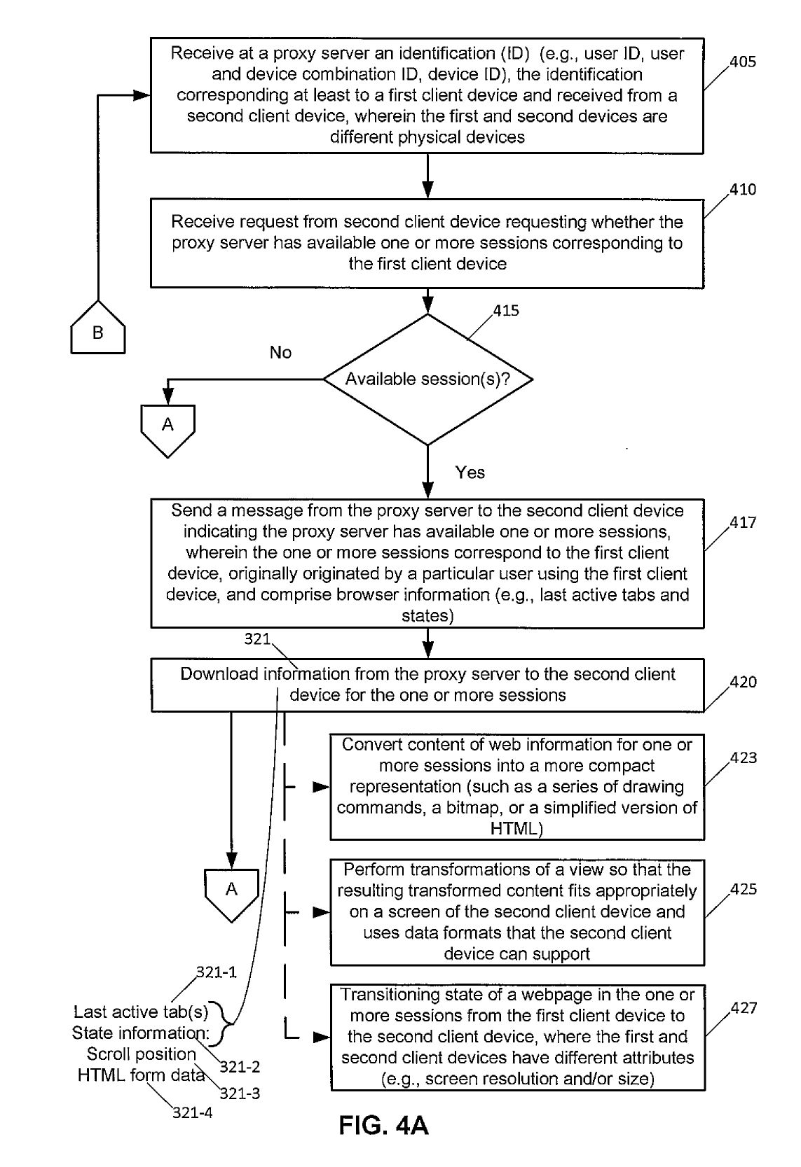

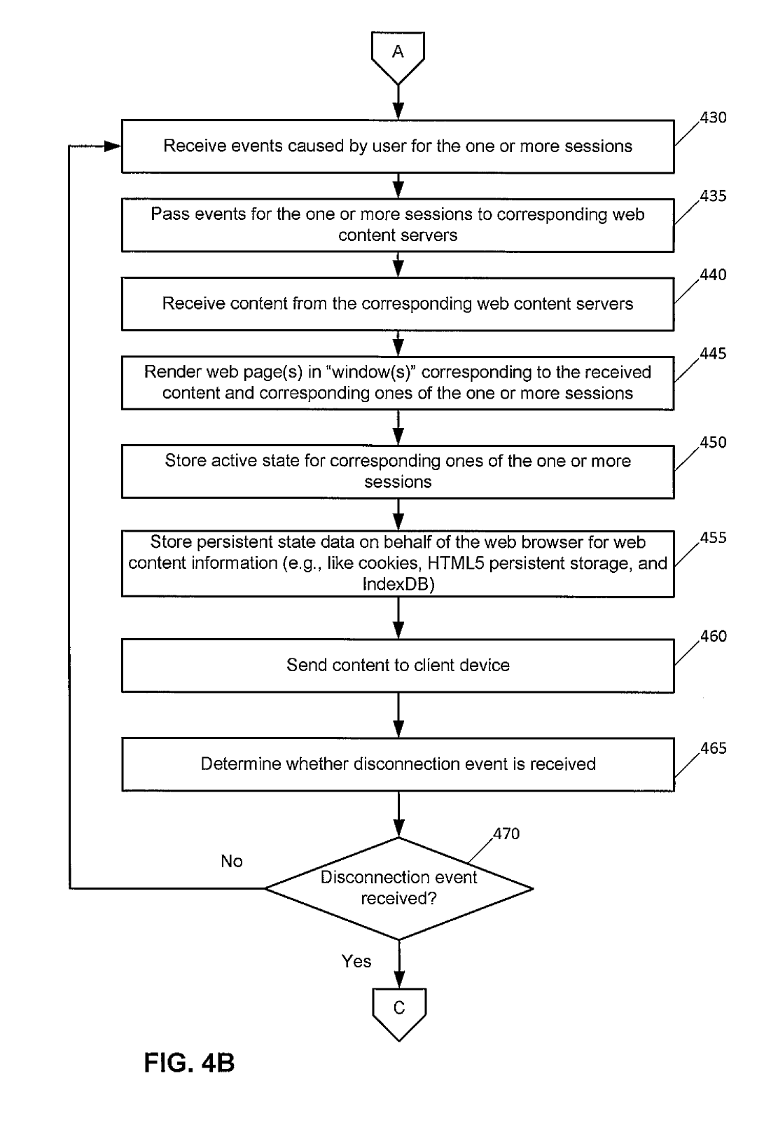

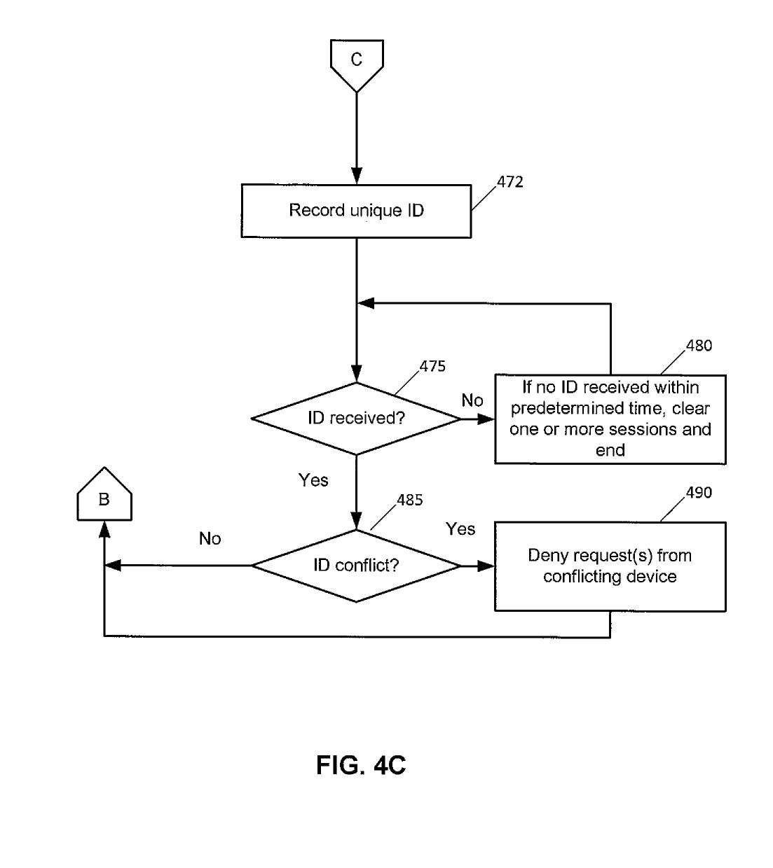

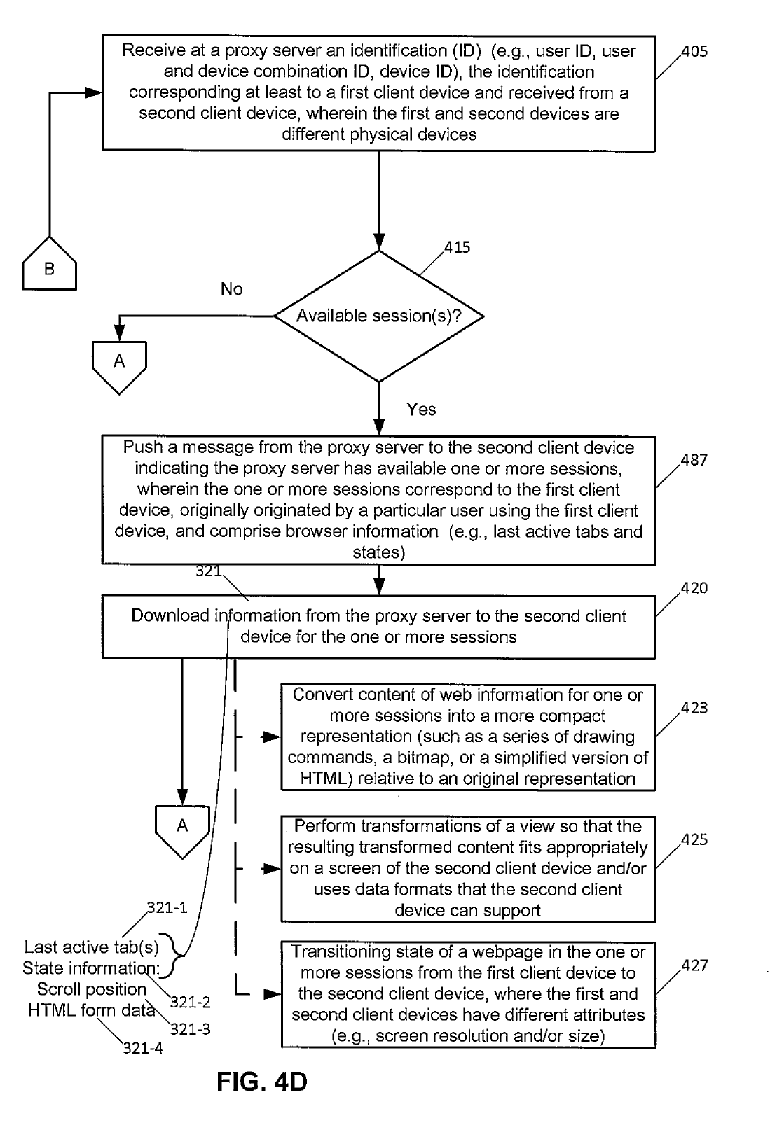

In terms of the flow in FIG. 3 (and similarly with FIG. 4), the flow begins with the assumption that the user has disconnected from the original client device 110-1, has begun using the second client device 110-2, and would like to continue browsing from the sessions originally begun on the first client device 110-1. The flow in FIG. 3 is therefore performed by the second client device 110-2, e.g., under control of the client rendering engine 220-2.

The flow in FIG. 3 begins in block 305, where the client device 110-2 provides identification (ID) from the second client device 110-2 to the proxy server 190. The ID corresponds at least to the first client device 110-1. The ID may be a user ID (corresponding to the first client device 110-1), a user and device combination ID, or a device ID for the first client device 110-1. Block 305 may rely on methods such as OAuth authentication. OAuth is an open standard for authorization. OAuth provides a method for clients to access server resources on behalf of a resource owner such as a client or an end user. OAuth also provides a process for end users to authorize third-party access to their server resources without sharing their credentials, typically a username and password pair, using user-agent redirections. Additionally or alternatively, block 305 may rely on other device pairing techniques such as Bluetooth (a wireless technology standard for exchanging data over short distances from fixed and mobile devices), near field communication (NFC) (a set of standards for smartphones and similar devices to establish radio communication with each other by touching them together or bringing them into proximity, usually no more than a few inches), or Quick Response (QR) codes (a type of matrix barcode or two-dimensional barcode that contains information about the item to which the label is attached). It is noted that block 305 may be performed at some point for multiple devices 110 by the user. For instance, a user may initially register multiple devices with the proxy server 190, such that the proxy server 190 can subsequently determine (via block 305) that a user is using one of the registered devices and the proxy server 190 should perform the methods herein. In another example, the user could log into, for instance via OAuth authentication and block 305, the proxy server 190 using a first client device and then subsequently log into the proxy server 190 again using a second client device. The logins themselves may operate to register the devices with the proxy server, e.g., if the proxy server can distinguish between the two client devices.

In block 310, the second client device 110-2 requests whether a proxy server has available one or more sessions, wherein the one or more web sessions correspond to the first client device, originally originated by a particular user using the first client device, and comprise browser information. Several user interaction paradigms are possible. A device (e.g., “device A”) could notify the proxy server about session handoff on exiting of the application, device lock screen, or inactivity period. Another device (e.g., “device B”), depending on capabilities and form factor, could present the last view page from the other device, present an open window (e.g., tabs) view with all remote and local windows for the user to decide a continuation point (or multiple points), or ask the user with a prompt if the user wishes to continue at the last known position/website.

In block 315, the second client device 110-2 determines whether the received message from the proxy server indicates one or more available sessions. If the received message from the proxy server indicates one or more available sessions (block 315=Yes) the second client device 110-2 downloads (block 320) information for the session(s) from the proxy server. Note that the message may include an indication of the last active tab(s) and state(s) at a point where the first client device left off in the one or more web sessions. For instance, the information 321 may include the last active tab(s) 321-1 and state information 321-2, which in this example includes scroll position 321-3 and HTML form data 321-4. If this is the case, the user may select some or all of the tabs, each of which typically corresponds to a web session. The scroll position 321-3 and HTML form data 321-4 can be used to replicate the previous session and corresponding webpage. In particular, the downloaded information 321 allows the second client device to render corresponding views of the one or more web sessions at a point where the first client device left off in the one or more web sessions. If the received message from the proxy server does not indicate one or more available sessions (block 315=No), the flow proceeds to block 330.

Block 330 (and blocks 355, 380, and 385) may be performed by either the first or second client devices 110-1 or 110-2. In block 330, the client device 110 performs normal browser functions. Examples of such functions include generating events caused by the user and sending the events to the proxy server 190 (block 335), rendering the content provided by the proxy server 190 (block 345), or modify the rendering based on user interaction (block 350). The events may be caused by a user scrolling up or down, a user clicking on a link or button, and the like. Modifying the rendering occurs in response to user interaction with the client rendering engine 220, where the user interaction causes the events (which are then generated and reported in block 335). In terms of rendering the content, if block 320 is performed, then the content in the downloaded information would be rendered appropriately. In particular, the downloaded information allows the second client device to render corresponding views of the one or more web sessions at a point where the first client device left off in the one or more web sessions. Block 320 would be performed for as long as the user is interacting with the client rendering engine 220 and until the user causes a disconnection event, which indicates the user has ceased interacting with one or more web sessions.

In block 355, the client device 110 determines whether the user has or will disconnect from the client device, therefore causing a disconnection event. Exemplary disconnection events may be caused by a user closing a browser (as client rendering engine 220) (block 360), a client device 110 locking (e.g., manually caused by the user or based on a timer) (block 365), a client device 110 going into low power mode (e.g., manually caused by the user or based on a timer) (block 370), or loss of another device's proximity (e.g., a smartphone is moved out of range of a PC) (block 375). More specifically, the client rendering engine 220 could receive a message from the operating system (not shown) that the user has manually set low power mode or a timer is about to expire and the client device 110 is going to enter low power mode. As another example of block 370, the client rendering engine 220 could determine the user has clicked on a “close” button for the client rendering engine 220. As a further example of block 375, an operating system could report to the client rendering engine 220 that a Bluetooth connection for the other client device has been lost.

If it is determined a user has not or will not disconnect (block 380=No), the flow proceeds to block 330, where normal browser functions are performed. If it is determined a user has or will disconnect (block 380=Yes), in block 385, the client device 110 reports a disconnection event to the proxy server 190.

In terms of a plug-in 223, the plug-in may perform the non-browser functions in an exemplary embodiment, such as blocks 305-320 and 355-385, while the browser (as the CRE 220) performs block 330.

Turning to FIG. 3C, FIG. 3C is a version of FIG. 3A. Most of the blocks in FIGS. 3A and 3C are the same and only the differences are described herein. In FIG. 3A, the client device 110 (110-2 in the example of FIG. 3A, but any client device can perform these blocks) requests whether the proxy server 190 has sessions available. Meanwhile, in FIG. 3C, the proxy server 190 pushes a message to the client device 110 regarding whether there are any sessions available (e.g., or not available). Thus, in block 390, the client device 110 receives a pushed message from proxy server indicating whether the proxy server 190 has available one or more sessions. As above, the one or more sessions correspond to the first client device, originally originated by a particular user using the second client device, and comprise browser information. If the pushed message from the proxy server 190 indicates there are available session(s) (block 395=Yes), the client device performs block 320. Otherwise (block 395=No), the flow proceeds to block 330.

Referring to FIG. 4, including FIGS. 4A, 4B, 4C, and 4D, where FIGS. 4A and 4D illustrate different possible examples, this figure is a block diagram of an exemplary logic flow diagram performed by a proxy server for continuous browsing across devices. This figure illustrates the operation of an exemplary method, a result of execution of computer program instructions embodied on a computer readable memory, and/or functions performed by logic implemented in hardware, in accordance with exemplary embodiments herein. The blocks in FIG. 4 may be considered to be interconnected means for performing the functions in the blocks. FIGS. 4A and 4B may be considered to be one flow, and FIGS. 4C and 4B may be considered to be another exemplary flow. FIGS. 4A and 4D are similar. FIG. 4A is related to an example where the client device requests whether there are sessions available, and FIG. 4D is related to an example where the proxy server pushes a message as to whether sessions are available.

Blocks 405-420 may be performed by the proxy server 190, e.g., under control of the user session/agent component 250. In block 405, the proxy server 190 receives an identification (ID), the identification corresponding at least to a first client device and received from a second client device, wherein the first and second devices are different physical devices. The ID may be a user ID (associated with the first client device), a user and device combination ID for the user and first client device, and a device ID for the first client device. In block 410, the proxy server 190 receives a request from a second client device 110-2 requesting whether the proxy server has available one or more sessions corresponding to the first client device. If there are not any available sessions (block 415=No) the flow proceeds to block 430. If there are available sessions (block 415=Yes), the proxy server 190 (block 417) sends a message from the proxy server 190 to the second client device 110-2 indicating the proxy server has available one or more sessions. As before, the one or more sessions correspond to the first client device, originally originated by a particular user using the first client device, and comprise browser information. The message may include an indication of the last active tab(s) and state(s) at a point where the first client device left off in the one or more web sessions.

In block 420, the proxy server downloads information from the proxy server to the second client device for the one or more sessions. As described above, the message may include an indication of the last active tab(s) and state(s) at a point where the first client device left off in the one or more web sessions. For instance, the information 321 may include the last active tab(s) 321-1 and state information 321-2, which in this example includes scroll position 321-3 and HTML form data 321-4. If this is the case, the user may select some or all of the tabs, each of which typically corresponds to a web session. The scroll position 321-3 and HTML form data 321-4 can be used to replicate the previous session and corresponding webpage. More particularly, the downloaded information 321 allows the second client device to render corresponding views of the one or more web sessions at a point where the first client device left off in the one or more web sessions.

Such downloading may also comprise converting content of web information for one or more sessions into a more compact representation (such as a series of drawing commands, a bitmap, or a simplified version of HTML) relative to an original representation (block 423) or performing transformations (block 425) of a view so that the resulting transformed content fits appropriately on a screen of the second client device and/or uses data formats that the second client device can support. For instance, PC screens and touch screens can be quite a bit different, and the screen formats can therefore be different. In particular, the screen formats for a smartphone or tablet can be much smaller and different sizes from screen formats for a PC. The data formats may similarly be different, e.g., iOS (an operating system by Apple) might require certain formats of picture or video files, while other operating systems for other devices may use different formats. It is noted that the proxy server can determine differences between the client devices (and corresponding screen formats and/or data formats) typically through known techniques. For instance, an internet-connected device that requests a web page via its browser may identify itself with a “User Agent” header string, and perhaps other header strings of varying types. Determining the type of browser or device from the User Agent header string (or other header strings) offers a web developer a source of extra data to allow server-side decisions to be made about how to configure or adapt the experience the end-user will receive. On the proxy server side, a JavaScript code may be used that identifies, e.g., iPhone, iPod, iPad, Blackberry, Palm, Android devices, Windows Compact Edition and any agent that includes “mobile”. Based on this, the proxy server can determine many characteristics of the client device, such as screen format, operating system, browser, and the like. Other techniques are also possible. Block 425 may be considered to be a more specific version of block 427, where downloading further comprises transitioning state of a webpage in the one or more sessions from the first client device to the second client device, where the first and second client devices have different attributes such as screen resolution or physical screen size or even attributes unrelated to screens (e.g., voice, picture, or video formats for instance, where two different devices support two different formats for one or more of these).

The flow proceeds to block 430. Blocks 430 and higher may be performed by any client device. In block 430, where the proxy server 190 receives events caused by the user for the one or more sessions. These events, for corresponding one or more sessions, are passed to the web content server(s) 170 in block 435. In return, in block 440, the proxy server 190 receives content from the corresponding web content server(s) 170. The proxy server 190 (e.g., the embedded web browser 230) renders corresponding web page(s) in window(s) 296 corresponding to the received content and corresponding ones of the one or more sessions in block 445. Note that it may be possible for the proxy server 190 to not render web page(s), e.g., instead some sequence of responses from the web content server(s) 170 could be stored without actual rendering of the web page(s) (but allowing such web page(s) to be rendered if necessary). In block 450, the proxy server 190 stores the active state for corresponding ones of the one or more sessions. In block 455, the proxy server 190 (e.g., the user session/agent component 250) stores persistent state data on behalf of the web browser 230 for web content information (e.g., like cookies, HTML5 persistent storage, and IndexDB). Note that use of the persistent state data by the proxy server allows the second client device to connect to a web session at a point where the first client device left off. In other words, if the user had logged into a website, the proxy server could store persistent state data including a link to a webpage that occurs after the user has logged in. The use of the link (e.g., and other stored persistent state data) by the proxy server for the subsequent access to the link by second client device allows the second client device to access the webpage at the link without having to reenter login information.

In block 460, the proxy server 190 sends content to the client device 110. If desired, blocks 423 and 425 may also be performed for block 460. However, the web content servers 170 may also send appropriate data to the client (e.g., a webpage for a smartphone may be different from a webpage for a PC), so the initial transition between client devices may be the only time blocks 423 and/or 425 are used (if they are used for an initial transition between devices). In block 465, the proxy server 190 determines whether a disconnection event is received. If a disconnection event is not received (block 470=No), the flow proceeds to block 430, where events (if any) from a user are received. If a disconnection event is received (block 470=Yes), in block 472, the unique ID corresponding to block 405 is recorded. In block 475, it is determined if an ID (e.g., from block 405) is received. If not (block 475=No), then in block 480, if not ID is received within some predetermined time (e g, minutes or hours as non-limiting examples), the one or more sessions corresponding to the ID are cleared and the flow ends. Block 480 therefore allows sessions to be cleared when the user likely will not access the sessions via another client device. If the ID is received (block 475=Yes), the flow proceeds to block 485, where it is determined if there is an ID conflict. For instance, if one device is currently accessing a website while another device tries to access the same website. If so (block 485=Yes), in block 490, the proxy server 190 denies request(s) from the conflicting device. If not (block 485=No), the flow proceeds to block 405. It is noted that the locations in the flow of FIG. 4 of blocks 475, 485, and 490 are merely exemplary, as any time the proxy server 190 receives an ID, these blocks could be performed to prevent conflicts between devices for access to the same website(s). Blocks 475, 485, and 490 prevent multiple client devices from attempting to access one or more web sessions and allow only a single client device to access the one or more web sessions at a time. Although unique IDs are one way of implementing this, other actions are possible. For instance, a user could log into the proxy server from each of the first and second client devices, and these login actions could be used to associate web sessions for both the first and second devices.

Turning to FIG. 4D, FIG. 4D is a version of FIG. 4A. Most of the blocks in FIGS. 4A and 4D are the same and only the differences are described herein. In FIG. 4A, the client device 110 (110-2 in the example of FIG. 4A, but any client device can perform these blocks) requests whether the proxy server 190 has sessions available. Meanwhile, in FIG. 4D, the proxy server 190 pushes a message to the client device 110 regarding whether there are any sessions available (e.g., or not available). Thus, there is no block 410 in FIG. 4D (since the proxy server does not receive a request from the client device as to whether there are sessions available). Instead, in block 487 (in response there being session(s) available, block 415=Yes), the proxy server pushes a message from the proxy server to the second client device indicating the proxy server has available one or more sessions. As before, the one or more sessions correspond to the first client device, originally originated by a particular user using the first client device, and comprise browser information. Additionally, the message may include an indication of the last active tab(s) and state(s) at a point where the first client device left off in the one or more web sessions.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 2. A computer-readable medium may comprise a computer-readable storage medium (e.g., memory(ies) 240, 293 or other device) that may be any media or means that can contain or store the instructions for use by or in connection with an instruction execution system, apparatus, or device, such as a computer. A computer readable storage medium does not, however, encompass propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
determining at a proxy server that one or more web sessions corresponding to a first client device are available for downloading by a second client device, wherein the one or more web sessions originally originated by a particular user using the first client device and comprise browser information, and wherein the first and second client devices are different physical devices;
sending a message from the proxy server to the second client device indicating the proxy server has available the one or more web sessions; and
downloading information from the proxy server to the second client device for the one or more web sessions, wherein the downloaded information allows the second client device to render corresponding views of the one or more web sessions at a point where the first client device left off in the one or more web sessions.

2. The method of claim 1, wherein:
the method further comprises receiving a request at the proxy server and from the second client device requesting whether the proxy server has available the one or more web sessions corresponding to the first client device;
the message is sent in response to the request by the second client device; and
the downloading information is performed subsequent to sending of the message.

3. The method of claim 1, wherein:
sending a message further comprises pushing the message from the proxy server to the second client device; and
performing the downloading information in response to pushing the message.

4. The method of claim 1, further comprising receiving an indication from the second client device, wherein the indication identifies at least the particular user, and wherein determining at a proxy server that one or more web sessions corresponding to a first client device are available for downloading by a second client device further comprises determining at the proxy server using the indication that one or more web sessions corresponding to the first client device are available for downloading by the second client device.

5. The method of claim 1, wherein screen formats between the first and second client devices are different, and downloading further comprises performing transformations of a view in the one or more sessions so that a resulting transformed content fits on a screen of the second client device.

6. The method of claim 5, wherein downloading further comprises performing transformations of the view using one or more data formats that the second client device can support.

7. The method of claim 1, wherein downloading further comprises converting content of web information for one or more sessions into a more compact representation relative to an original representation.

8. The method of claim 1, further comprising determining whether multiple client devices attempt to access the one or more web sessions and allowing only a single client device to access the one or more web sessions at a time.

9. The method of claim 8, further comprising storing a unique identification corresponding to the one or more sessions for at least the particular user and determining whether multiple client devices attempt to access the one or more web sessions further comprises determining whether the unique identification is provided by the multiple client devices to the proxy server, and wherein storing the unique identification corresponding to the one or more sessions for at least the particular user is performed in response to receiving a disconnection event from the first or second client device.

10. The method of claim 1, further comprising the proxy server passing events from the first or second client devices for the one or more sessions to corresponding web content servers, receiving content from the corresponding web content servers, and sending content from the web content servers to a corresponding one of the first or second client devices.

11. The method of claim 10, further comprising rendering one or more web pages in one or more windows corresponding to received content from the web content servers and corresponding to ones of the one or more sessions and wherein sending content further comprises sending content from the rendered content to the corresponding one of the first or second client devices.

12. The method of claim 10, further comprising storing persistent state data corresponding to the events, wherein use of the persistent state data by the proxy server allows the second client device to connect to a particular web session at a point where the first client device left off in the particular web session.

13. The method of claim 1, wherein downloading further comprises transitioning state of a webpage in the one or more sessions from the first client device to the second client device, where the first and second client devices have different attributes.

14. The method of claim 1, further comprising the proxy server performing a long running process and sending an indication to the second client device that results for the long running process are complete.

15. The method of claim 1, further comprising the proxy server notifying the second client device about one or more last active tabs and corresponding states at a point where the first client device left off in the one or more web sessions.

16. A method, comprising:
determining from a proxy server that one or more web sessions corresponding to a first client device are available for downloading by a second client device, wherein the one or more web sessions originally originated by a particular user using the first client device and comprise browser information, and wherein the first and second client devices are different physical devices; and
downloading information, by the second client device and from the proxy server, responsive to the determining for the one or more web sessions, wherein the downloaded information allows the second client device to render corresponding views of the one or more web sessions at a point where the first client device left off in the one or more web sessions.

17. The method of claim 16, further comprising rendering the corresponding views of the one or more web sessions at the point where the first client device left off in the one or more web sessions.

18. The method of claim 16, wherein:
the method further comprises, prior to determining, sending a request from the second client device and toward the proxy server, the request requesting whether the proxy server has available the one or more web sessions corresponding to the first client device;
the method further comprises receiving, responsive to sending the request, at the second client device a message from the proxy server indicating the proxy server has available the one or more web sessions; and
the determining further comprises determining from the proxy server that the one or more web sessions corresponding to the first client device are available for downloading by using the message.

19. The method of claim 16, wherein:
the method further comprises receiving a message pushed from the proxy server to the second client device indicating the proxy server has available the one or more web sessions; and
the determining further comprises determining from the proxy server that the one or more web sessions corresponding to the first client device are available for downloading by using the pushed message.

20. The method of claim 16, further comprising sending an indication from the second client device toward the proxy server, wherein the indication identifies at least the particular user.

21. The method of claim 16, further comprising determining a disconnection event has occurred indicating the particular user has ceased interacting with the one or more web sessions, and sending an indication of the disconnection event toward the proxy server.
